(19) United States
(12) Patent Application Publication
(10) Pub. No.: US 2014/0248840 A1
(43) Pub. Date: Sep. 4, 2014

(54) ADAPTIVE FILTERING OF CELL MEASUREMENTS

(71) Applicant: APPLE INC., Cupertino, CA (US)

(72) Inventors: Sai Sravan Bharadwaj Karri, Santa Clara, CA (US); Sunny Arora, Sunnyvale, CA (US)

(73) Assignee: APPLE INC., Cupertino, CA (US)

(21) Appl. No.: 13/783,085

(22) Filed: Mar. 1, 2013

(51) Int. Cl. H04W 24/02

(52) U.S. Cl. CPC H04W 24/02
USPC 455/67.11

(57) ABSTRACT

A method for adaptive filtering of cell measurements is provided. The method can include a wireless communication device determining based on instantaneous measurement samples of a cell captured over a measurement period that a fading condition of the cell exceeds a threshold. The method can further include the wireless communication device modifying a network configured filter coefficient to derive a modified filter coefficient in response to the fading condition of the cell exceeding the threshold over the measurement period. The method can additionally include the wireless communication device filtering the instantaneous measurement samples based on the modified filter coefficient to calculate a filtered measurement of the cell. The method can also include the wireless communication device calculating an adjusted measurement value for the cell based on the filtered measurement. The method can further include the wireless communication device using the adjusted measurement value for event evaluation and reporting.

### FIELD OF THE DESCRIBED EMBODIMENTS

The described embodiments relate generally to wireless communications and more particularly to adaptive filtering of cell measurements.

### BACKGROUND

Wireless communication devices operating on a cellular network, such as a Long Term Evolution (LTE) network, are generally configured to report cell measurements for a current serving cell and/or for one or more neighbor cells to support possible handovers. For example, in an LTE network a wireless communication device can be required to report reference signal received power (RSRP) and reference signal received quality (RSRQ) measurements for defined events. In many networks, a wireless communication device is configured to report a filtered measurement calculated in accordance with a network configured filter coefficient from a set of instantaneous measurement samples that can be captured over a measurement period that can be defined by the network.

The filtered measurements that are used for event evaluation and reporting can lag behind the instantaneous measurement samples. In this regard, in fast fading channel conditions, a measurement filtered using the network configured filter coefficient can weight samples captured earlier in the measurement period such that the filtered average of the measurement samples can mask fast fading channel conditions reflected by instantaneous measurement samples captured later in the measurement period. This lag can lead to a delay in the triggering of reporting events, and thus a delay in device handover. In some instances, this delay can result in call drops.

### SUMMARY OF THE DESCRIBED EMBODIMENTS

Some example embodiments disclosed herein provide for adaptive filtering of cell measurements. In this regard, a wireless communication device in accordance with some example embodiments can be configured to modify a network configured filter coefficient and to use the resulting modified filter coefficient for calculating a filtered cell measurement in fading channel conditions. The filtered measurement calculated based on the modified filter coefficient may be more reflective of a more current instantaneous measurement sample so that event reporting and handover can be triggered more quickly in fast fading channel conditions. Users may accordingly benefit from reduced call drop frequency in fast fading channel conditions.

In a first embodiment, a method for adaptive filtering of cell measurements is provided. The method of the first embodiment can include a wireless communication device calculating a first filtered measurement of a cell based on a network configured filter coefficient. The first filtered measurement can be indicative of a channel condition of the cell over a first measurement period. The method of the first embodiment can further include the wireless communication device determining based at least in part on a plurality of instantaneous measurement samples of the cell captured over a second measurement period that a fading condition of the cell over the second measurement period exceeds a first threshold. The method of the first embodiment can additionally include the wireless communication device modifying the network configured filter coefficient to derive a modified filter coefficient in response to the fading condition of the cell exceeding the first threshold over the second measurement period. The method of the first embodiment can also include the wireless communication device filtering the plurality of instantaneous measurement samples based on the modified filter coefficient to calculate a second filtered measurement of the cell. The method of the first embodiment can further include the wireless communication device comparing the first filtered measurement and the second filtered measurement. In an instance in which a difference between the second filtered measurement and the first filtered measurement exceeds a second threshold, the method of the first embodiment can also include the wireless communication device clipping the second filtered measurement to derive a clipped value; and calculating an adjusted measurement value for the cell based at least in part on the clipped value. In an instance in which the difference between the second filtered measurement and the first filtered measurement does not exceed the second threshold, the method of the first embodiment can instead include the wireless communication device calculating the adjusted measurement value directly from the second filtered measurement value. The method of the first embodiment can additionally include the wireless communication device using the adjusted measurement value for event evaluation and reporting.

In a second embodiment, another method for adaptive filtering of cell measurements is provided. The method of the second embodiment can include a wireless communication device determining based at least in part on a plurality of instantaneous measurement samples of a cell captured over a measurement period that a fading condition of the cell over the measurement period exceeds a threshold. The method of the second embodiment can further include the wireless communication device modifying a network configured filter coefficient to derive a modified filter coefficient in response to the fading condition of the cell exceeding the threshold over the measurement period. The method of the second embodiment can additionally include the wireless communication device filtering the plurality of instantaneous measurement samples based on the modified filter coefficient to calculate a filtered measurement of the cell. The method of the second embodiment can also include the wireless communication device calculating an adjusted measurement value for the cell based at least in part on the filtered measurement. The method of the second embodiment can further include the wireless communication device using the adjusted measurement value for event evaluation and reporting.

In a third embodiment, a wireless communication device is provided. The wireless communication device of the third embodiment can include a transceiver and processing circuitry coupled to the transceiver. The transceiver can be configured to transmit data to and receive data from a cellular network. The processing circuitry can be configured to control the wireless communication device to at least determine based at least in part on a plurality of instantaneous measurement samples of a cell captured over a measurement period that a fading condition of the cell over the measurement period exceeds a threshold; modify a network configured filter coefficient to derive a modified filter coefficient in response to the fading condition of the cell exceeding the threshold over the measurement period; filter the plurality of instantaneous measurement samples based on the modified filter coefficient to calculate a filtered measurement of the cell; calculate an adjusted measurement value for the cell based at least in part on the filtered measurement; and use the adjusted measurement value for event evaluation and reporting.

In a fourth embodiment, a computer program product for adaptive filtering of cell measurements is provided. The computer program product of the fourth embodiment can include at least one non-transitory computer readable storage medium having program code stored thereon. The program code of the fourth embodiment can include program code for determining based at least in part on a plurality of instantaneous measurement samples of a cell captured over a measurement period that a fading condition of the cell over the measurement period exceeds a threshold; program code for modifying a network configured filter coefficient to derive a modified filter coefficient in response to the fading condition of the cell exceeding the threshold over the measurement period; program code for filtering the plurality of instantaneous measurement samples based on the modified filter coefficient to calculate a filtered measurement of the cell; program code for calculating an adjusted measurement value for the cell based at least in part on the filtered measurement; and program code for using the adjusted measurement value for event evaluation and reporting.

In a fifth embodiment, an apparatus for adaptive filtering of cell measurements is provided. The apparatus of the fifth embodiment can include means for determining based at least in part on a plurality of instantaneous measurement samples of a cell captured over a measurement period that a fading condition of the cell over the measurement period exceeds a threshold; means for modifying a network configured filter coefficient to derive a modified filter coefficient in response to the fading condition of the cell exceeding the threshold over the measurement period; means for filtering the plurality of instantaneous measurement samples based on the modified filter coefficient to calculate a filtered measurement of the cell; means for calculating an adjusted measurement value for the cell based at least in part on the filtered measurement; and means for using the adjusted measurement value for event evaluation and reporting.

The above summary is provided merely for purposes of summarizing some example embodiments of the invention so as to provide a basic understanding of some aspects of the invention. Accordingly, it will be appreciated that the above described example embodiments are merely examples and should not be construed to narrow the scope or spirit of the invention in any way. Other embodiments, aspects, and advantages of the invention will become apparent from the following detailed description taken in conjunction with the accompanying drawings which illustrate, by way of example, the principles of the described embodiments.

### BRIEF DESCRIPTION OF THE DRAWINGS

The described embodiments and the advantages thereof may best be understood by reference to the following description taken in conjunction with the accompanying drawings. These drawings are not necessarily drawn to scale, and in no way limit any changes in form and detail that may be made to the described embodiments by one skilled in the art without departing from the spirit and scope of the described embodiments.

FIG. 1 illustrates an example scenario in which a wireless communication device can encounter fast fading channel condition in accordance with some example embodiments.

FIG. 2 illustrates an example measurement scenario in a fast fading channel condition.

FIG. 3 illustrates an example wireless communication system in accordance with some example embodiments.

FIG. 4 illustrates a block diagram of an apparatus that can be implemented on a wireless communication device in accordance with some example embodiments.

FIG. 5 illustrates a flowchart according to an example method for adaptive filtering of cell measurements according to some example embodiments.

FIG. 6 illustrates a flowchart according to an example method for determining existence of a fading condition and initiating adaptive filtering according to some example embodiments.

FIG. 7 illustrates a flowchart according to another example method for adaptive filtering of cell measurements according to some example embodiments.

FIG. 8 illustrates a flowchart according to an example method for resuming usage of a network configured filter coefficient after initiation of adaptive filtering according to some example embodiments.

FIG. 9 illustrates a graph of instantaneous versus filtered measurements for a sample set of test data using both static filtering and adaptive filtering.

### DETAILED DESCRIPTION OF SELECTED EMBODIMENTS

Representative applications of methods and apparatus according to the present specification are described in this section. These examples are being provided solely to add context and aid in the understanding of the described embodiments. It will thus be apparent to one skilled in the art that the described embodiments may be practiced without some or all of these specific details. In other instances, well known process steps have not been described in detail in order to avoid unnecessarily obscuring the described embodiments. Other applications are possible, such that the following examples should not be taken as limiting.

In the following detailed description, references are made to the accompanying drawings, which form a part of the description and in which are shown, by way of illustration, specific embodiments in accordance with the described embodiments. Although these embodiments are described in sufficient detail to enable one skilled in the art to practice the described embodiments, it is understood that these examples are not limiting; such that other embodiments may be used, and changes may be made without departing from the spirit and scope of the described embodiments.

In typical cellular network deployments, a wireless communication device can be configured to perform measurements for a current serving cell and/or for one or more neighbor cells to support potential handovers. For example, in LTE networks, a wireless communication device can be configured by a serving evolved Node B (eNB) to report RSRP and RSRQ measurements for events, such as A3 and A2, as defined in the Third Generation Partnership Project (3GPP) TS 36.331 specification. The wireless communication device can be configured to take measurements at least once in a measurement period that can be defined by the network and the wireless communication device can be configured to filter the measurements according to a network configured filter coefficient. The network configured filter coefficient can be signaled to the wireless communication device by the serving base station in radio resource control (RRC) reconfiguration signaling.

The sampling rate at which a wireless communication device captures instantaneous measurement samples can be left up to the device, and can vary by implementation. As an example, a wireless communication device operating on an LTE network can capture RSRP and/or RSRQ measurement samples every 40 milliseconds (ms) and can filter measurement samples over a measurement period, such as a 200 ms measurement period. While the network configured filter coefficient can provide stability in measurements and avoid unnecessarily triggering a handover due to a single instantaneous measurement sample that may be an aberration, a filtered measurement can lag behind instantaneous measurements in fast fading channel conditions to an extent to which event reporting and handover may be delayed to the detriment of an ongoing call, which may be dropped as a result of the delay.

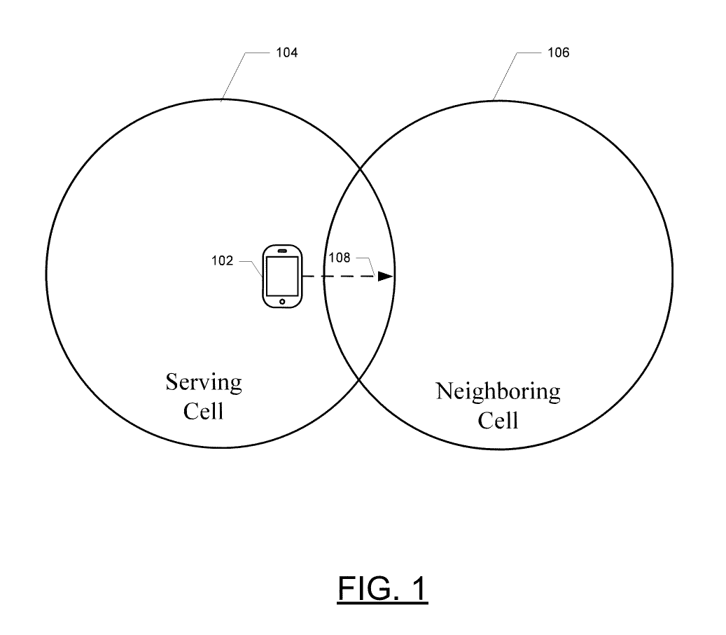

Fast fading channel conditions can occur in a variety of scenarios. One such scenario is mobility of a device toward an edge of a serving cell, as illustrated in FIG. 1. In this regard, a wireless communication device 102 can be served by serving cell 104, which can be adjacent to neighboring cell 106. The wireless communication device 102 can travel along a path 108 toward the boundary of the serving cell 104 and into range of the neighboring cell 106. The wireless communication device 102 can encounter a fast fading channel condition due to mobility along the path 108 as it approaches the boundary of the serving cell 104.

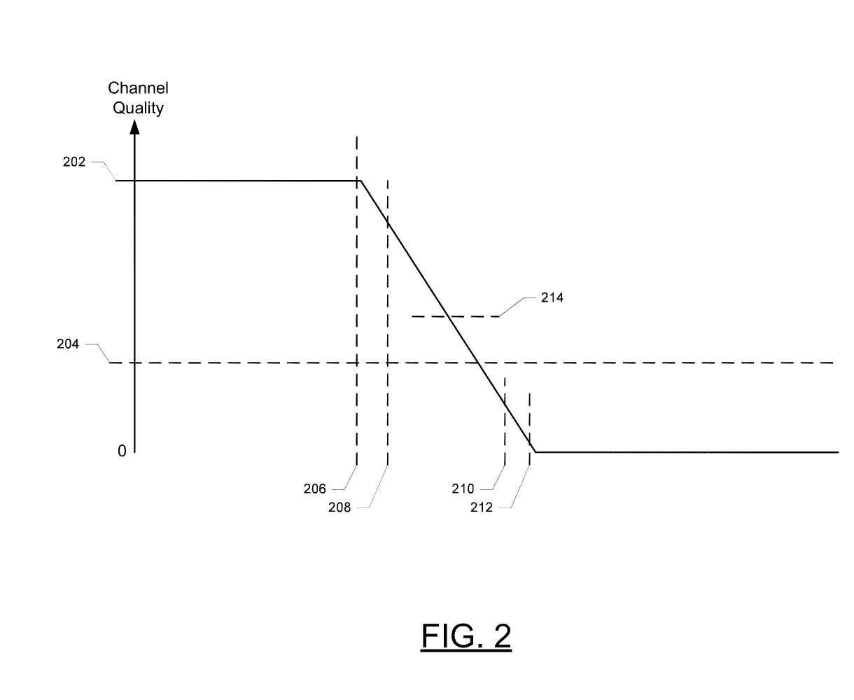

As an example, FIG. 2 illustrates example measurement scenario in a fast fading channel condition, such as may be encountered by the wireless communication device 102 as it approaches the edge of the serving cell 104 during mobility along the path 108. As illustrated in FIG. 2, the channel quality 202 of the serving cell 104 that can be experienced by the wireless communication device 102 can rapidly degrade as it approaches the boundary of the serving cell 104. The threshold channel quality 204 is illustrative of an example threshold channel quality that can be configured to trigger event reporting and/or handover to another cell. Over the course of a measurement period, the wireless communication device 102 can capture the instantaneous measurement samples 206, 208, 210, and 212. The measurement samples 206 and 208 can reflect a high channel quality. The measurement samples 210 and 212, which can be captured after the wireless communication device 102 begins to experience a fast fading channel condition, can reflect a poor channel quality that is below the threshold channel quality 204. As such, the current channel conditions experienced by the wireless communication device 102 at the end of a measurement period in which the device is experiencing a fast fading channel condition can be sufficient to trigger event reporting and handover. However, calculation of the filtered measurement value in accordance with the network configured filter coefficient can result in a filtered average 214, which does not satisfy the threshold channel quality 204. As such, the wireless communication device 102 can remain on the serving cell 104 for at least another measurement period even though it can be experiencing channel conditions that can lead to call drops.

Some example embodiments address the problem illustrated in FIG. 2 by applying adaptive filtering through usage of a modified filter coefficient, as will be described further herein below, in the event that a fast fading channel condition is detected. The resulting filtered measurement value can be more reflective of current channel conditions (e.g., of the more recent instantaneous measurement samples 210 and 212) such that an event reporting threshold (e.g., the threshold channel quality 204) can be satisfied more quickly and the wireless communication device can be handed over to a neighboring cell (e.g., the neighboring cell 106) before a call drop occurs.

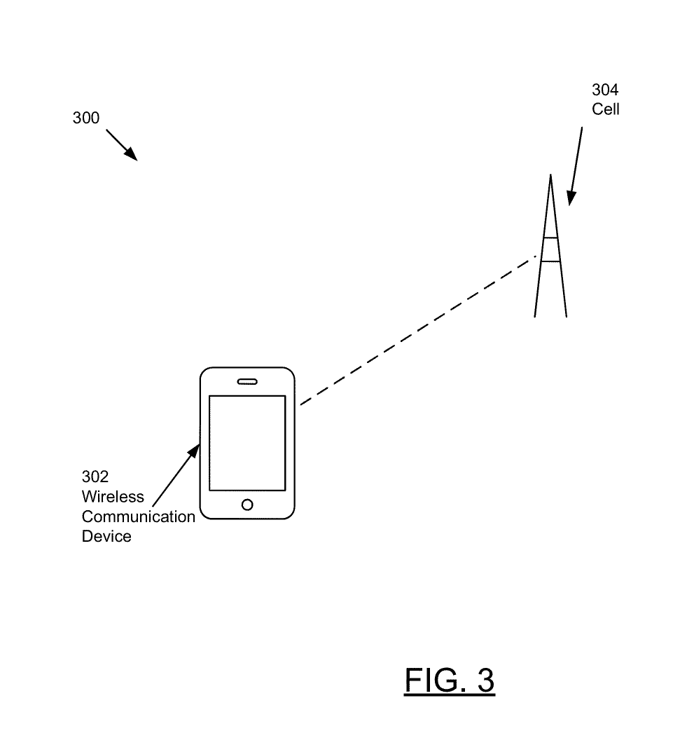

FIG. 3 illustrates an example wireless communication system 300 in accordance with some example embodiments. The system 300 can include a wireless communication device 302, which can be embodied as any computing device that can be configured to connect to a cellular network. By way of non-limiting example, the wireless communication device 302 can be a cellular phone, such as a smart phone device; a tablet computing device; a laptop computing device; or other computing device that can be configured to connect to a cellular network.

The wireless communication device 302 can be within signaling range of a cell 304, and can take measurements of the cell 304. The cell 304 can be a serving cell for the wireless communication device 302, or can be a neighboring cell of the device's serving cell. The cell 304 can be a cell of a network using any present or future developed cellular network technology. By way of non-limiting example, the cell 304 can be a cell of a network using an LTE technology, such as LTE, LTE-Advanced (LTE-A), or other present or future developed LTE technology. It will be appreciated, however, that embodiments described with respect to LTE networks and standards are provided by way of example, and not by way of limitation. In this regard, in some example embodiments, the cell 304 can be a cell of a non-LTE network, including, for example, a third generation (3G) network, such as a Wideband Code Division Multiple Access (WCDMA) or other Universal Mobile Telecommunications System (UMTS) network, such as a Time Division Synchronous Code Division Multiple Access (TD-SCDMA) network; a CDMA2000 network; 1xRTT network, or the like. As another example, cell 304 can be a cell of a second generation (2G) network such as a Global System for Mobile Communications (GSM) network.

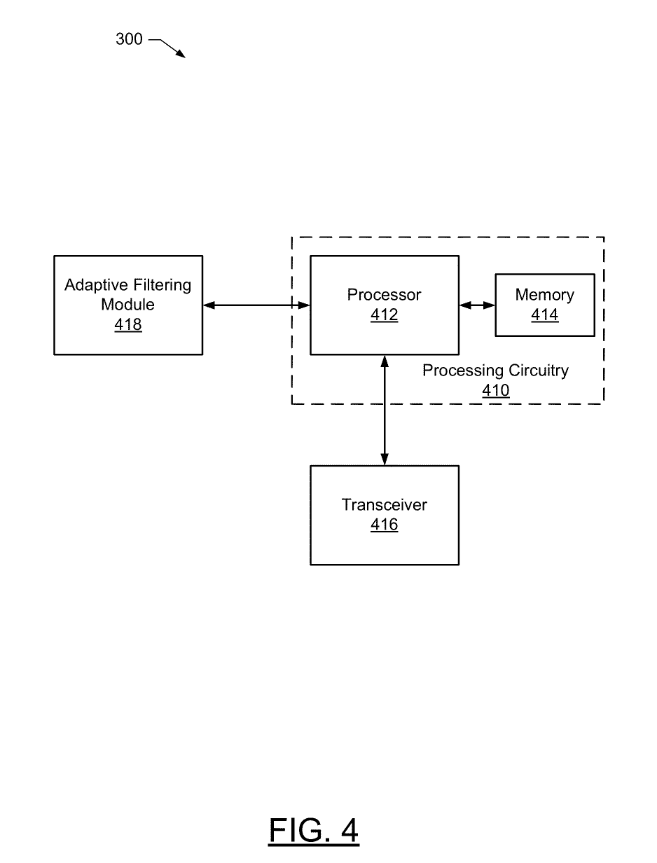

FIG. 4 illustrates a block diagram of an apparatus 400 that can be implemented on a wireless communication device 302 in accordance with some example embodiments. In this regard, when implemented on a computing device, such as wireless communication device 302, apparatus 400 can enable the computing device to operate within the system 300 in accordance with one or more example embodiments. It will be appreciated that the components, devices or elements illustrated in and described with respect to FIG. 4 below may not be mandatory and thus some may be omitted in certain embodiments. Additionally, some embodiments can include further or different components, devices or elements beyond those illustrated in and described with respect to FIG. 4.

In some example embodiments, the apparatus 400 can include processing circuitry 410 that is configurable to perform actions in accordance with one or more example embodiments disclosed herein. In this regard, the processing circuitry 410 can be configured to perform and/or control performance of one or more functionalities of the apparatus 400 in accordance with various example embodiments, and thus can provide means for performing functionalities of the apparatus 400 in accordance with various example embodiments. The processing circuitry 410 can be configured to perform data processing, application execution and/or other processing and management services according to one or more example embodiments.

In some embodiments, the apparatus 400 or a portion(s) or component(s) thereof, such as the processing circuitry 410, can include one or more chipsets, which can each include one or more chips. The processing circuitry 410 and/or one or more further components of the apparatus 400 can therefore, in some instances, be configured to implement an embodiment on a chipset(s). In some example embodiments in which one or more components of the apparatus 400 are embodied as a chipset, the chipset can be capable of enabling a computing device to operate in the system 300 when implemented on or otherwise operably coupled to the computing device. Thus, for example, one or more components of the apparatus 400 can provide a cellular baseband chipset, which can enable a computing device to operate within a cellular network.

In some example embodiments, the processing circuitry 410 can include a processor 412 and, in some embodiments, such as that illustrated in FIG. 4, can further include memory 414. The processing circuitry 410 can be in communication with or otherwise control a transceiver 416 and/or adaptive filtering module 418.

The processor 412 can be embodied in a variety of forms. For example, the processor 412 can be embodied as various hardware-based processing means such as a microprocessor, a coprocessor, a controller or various other computing or processing devices including integrated circuits such as, for example, an ASIC (application specific integrated circuit), an FPGA (field programmable gate array), some combination thereof, or the like. Although illustrated as a single processor, it will be appreciated that the processor 412 can comprise a plurality of processors. The plurality of processors can be in operative communication with each other and can be collectively configured to perform one or more functionalities of the apparatus 400 as described herein. In some example embodiments, the processor 412 can be configured to execute instructions that can be stored in the memory 414 or that can be otherwise accessible to the processor 412. As such, whether configured by hardware or by a combination of hardware and software, the processor 412 can be capable of performing operations according to various embodiments while configured accordingly.

In some example embodiments, the memory 414 can include one or more memory devices. Memory 414 can include fixed and/or removable memory devices. In some embodiments, the memory 414 can provide a non-transitory computer-readable storage medium that can store computer program instructions that can be executed by the processor 412. In this regard, the memory 414 can be configured to store information, data, applications, instructions and/or the like for enabling the apparatus 400 to carry out various functions in accordance with one or more example embodiments. In some embodiments, the memory 414 can be in communication with one or more of the processor 412, transceiver 416, or adaptive filtering module 418 via a bus(es) for passing information among components of the apparatus 400.

The apparatus 400 can further include transceiver 416. The transceiver 416 can enable the apparatus 400 to send wireless signals to and receive signals from one or more cellular networks. As such, the transceiver 416 can be configured to support any type of cellular technology that can be implemented by the cell 304, and can facilitate measurement of a channel quality of the cell 304.

The apparatus 400 can further include adaptive filtering module 418. The adaptive filtering module 418 can be embodied as various means, such as circuitry, hardware, a computer program product comprising a computer readable medium (for example, the memory 414) storing computer readable program instructions executable by a processing device (for example, the processor 412), or some combination thereof. In some embodiments, the processor 412 (or the processing circuitry 410) can include, or otherwise control the adaptive filtering module 418.

The adaptive filtering module 418 can be configured to perform adaptive filtering of cell measurements in accordance with one or more example embodiments, as described further herein below. In this regard, the adaptive filtering module 418 can be configured to calculate filtered measurements of a cell, such as the cell 304, based on instantaneous measurement samples of the cell. In fast fading channel conditions, the adaptive filtering module 418 can be configured to modify a network configured filter coefficient to derive a modified filter coefficient and use the modified filter coefficient to calculate a filtered measurement. The adaptive filtering module 418 can be further configured to use a filtered measurement as a basis for event evaluation and reporting.

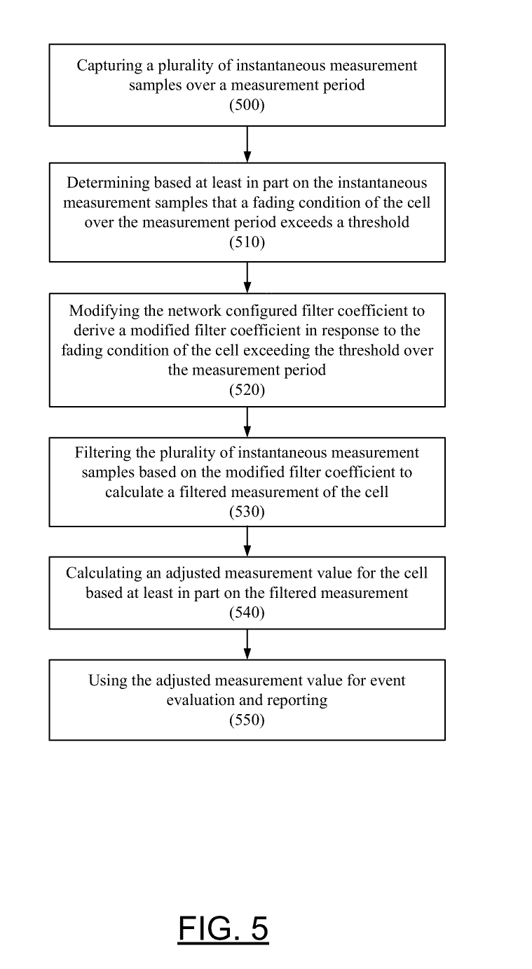

FIG. 5 illustrates a flowchart according to an example method for adaptive filtering of cell measurements according to some example embodiments. In this regard, FIG. 5 illustrates operations that can be performed by the wireless communication device 302 in accordance with some example embodiments. One or more of processing circuitry 410, processor 412, memory 414, transceiver 416, or adaptive filtering module 418 can, for example, provide means for performing the operations illustrated in and described with respect to FIG. 5.

Operation 500 can include the wireless communication device 302 capturing a plurality of instantaneous measurement samples of the cell 304 over a measurement period. The measurement period can be a measurement period defined by the network, such as through RRC signaling. By way of non-limiting example, the measurement period can be 200 ms. The instantaneous measurement samples can be captured in accordance with a sampling rate that can be selected by the wireless communication device 302. For example, in some embodiments, the wireless communication device 302 can use a 40 ms sampling rate, and can capture 5 samples per 200 ms measurement period. The instantaneous measurement samples can be maintained in a buffer. Thus, for example, in some embodiments, if five instantaneous measurement samples are captured in a measurement period, measurement samples x₁, x₂, x₃, x₄, and x₅ can be maintained in a buffer. Embodiments utilizing a buffer can, for example, implement a rolling buffer having a size that can be defined based at least in part on a sampling rate and measurement period length such that older instantaneous measurement samples can be replaced in the buffer by newly captured instantaneous measurement samples.

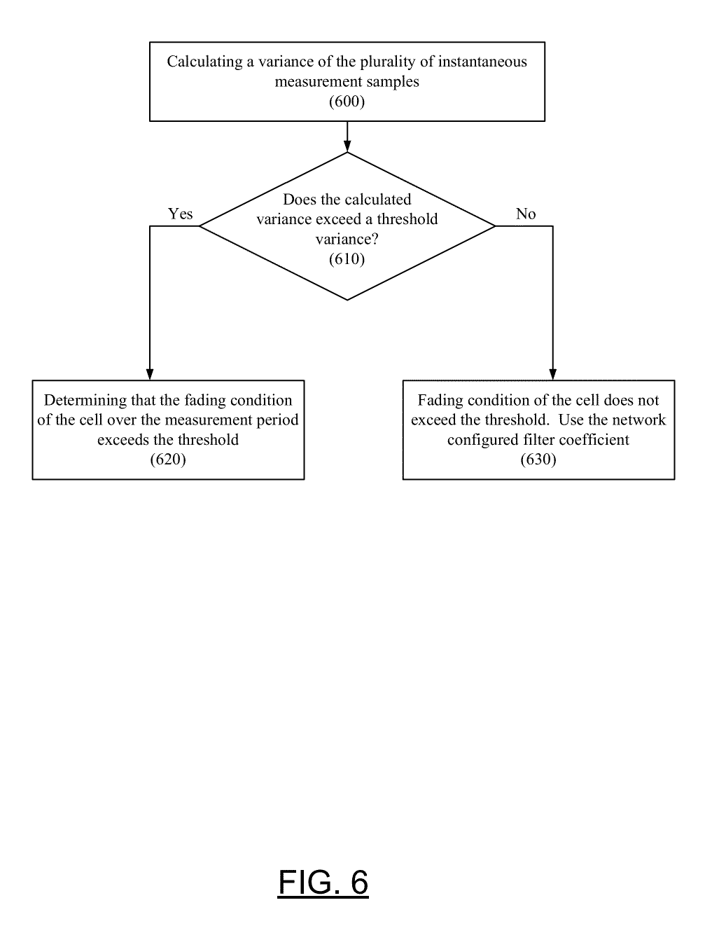

Operation 510 can include the wireless communication device 302 determining based at least in part on the instantaneous measurement samples captured during the measurement period that a fading condition of the cell 304 over the measurement period exceeds a threshold. In this regard, operation 510 can include the wireless communication device 302 comparing and/or otherwise evaluating the instantaneous measurement samples to detect whether channel degradation over the measurement period exceeds a threshold level of fading. For example, in some embodiments, operation 510 can include the wireless communication device 302 determining a statistical spread of two or more instantaneous measurements to determine whether the spread exceeds a threshold. In some example embodiments, such as that illustrated and described further with respect to FIG. 6, operation 510 can include calculating a variance of the instantaneous measurement samples and determining whether the variance of the samples exceeds a threshold variance.

Operation 520 can include the wireless communication device 302 modifying the network configured filter coefficient to derive a modified filter coefficient in response to the fading condition of the cell 304 exceeding the threshold over the measurement period. In this regard, the network configured filter coefficient can be increased so that a resulting filtered measurement value will be more reflective of current channel conditions. In some example embodiments, the network configured filter coefficient can be increased by a factor, k. In some example embodiments, k can be a static value, such as between 4 and 7. Alternatively, in some example embodiments, k can be selected based at least in part on an extent of the fading condition over the measurement period. In this regard, k can be proportional to an amount of observed fading. For example, a higher k value can be selected for conditions exhibiting faster fading and/or an otherwise greater magnitude in channel degradation than for conditions exhibiting a lesser degree of fading.

Operation 530 can include the wireless communication device 302 filtering the plurality of instantaneous measurement samples based on the modified filter coefficient to calculate a filtered measurement of the cell 304. Operation 304 can include the wireless communication device 302 calculating an adjusted measurement value for the cell 304 based at least in part on the filtered measurement. In this regard, the adjusted measurement value can reflect an adjustment that can result from usage of the modified filter coefficient such that the adjusted measurement value can be more reflective of current channel conditions than a measurement value calculated based on the network configured filter coefficient.

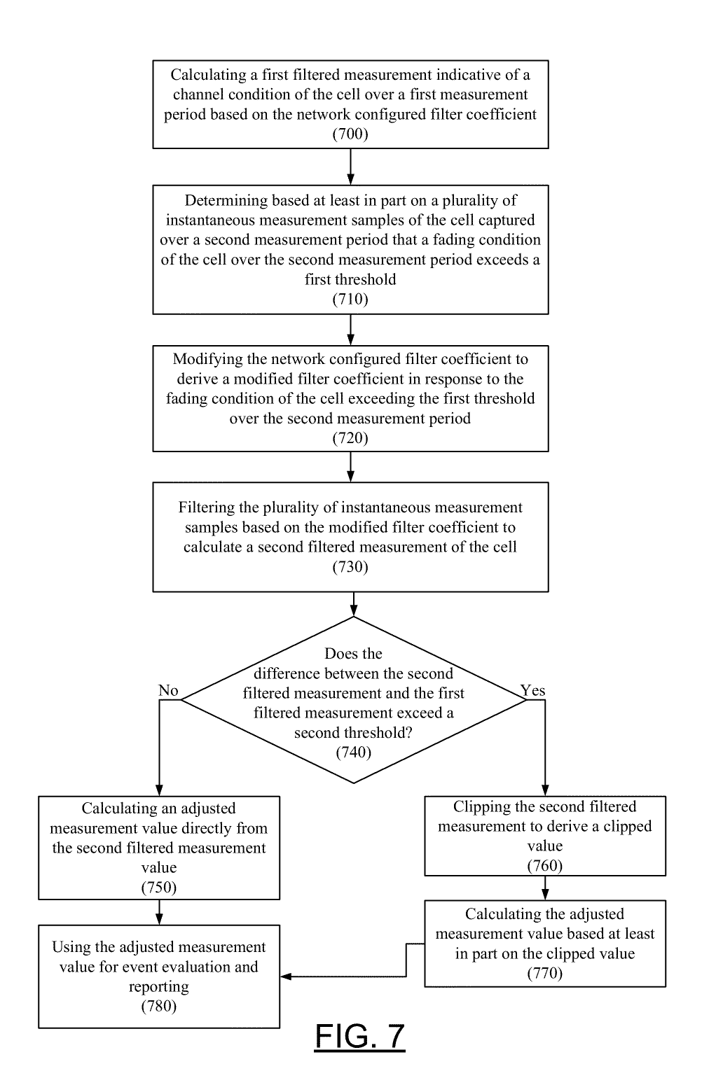

In some instances, the adjusted measurement value can be equivalent to the filtered measurement calculated in operation 530. However, in other instances, one or more further measurement values can be calculated directly from the filtered measurement value and/or from a modified version of the filtered measurement value, such as a clipped version of the filtered measurement value, as discussed with respect to FIG. 7. The adjusted measurement value can be any measurement metric that can be used for cell evaluation and/or handover purposes. For example, the adjusted measurement value can include an RSRP and/or RSRQ value for the cell 304, such as in embodiments in which the cell 304 is a cell of an LTE network. It will be appreciated, however, that other measurement values that can be used to measure a channel quality can be calculated in addition to or in lieu of RSRP and/or RSRQ within the scope of various example embodiments, including, for example, received signal code power (RSCP), received signal strength indicator (RSSI), bit energy on the spectral noise density (Eb/No), Ec/Io, and/or the like.

Operation 550 can include the wireless communication device 302 using the adjusted measurement value for event evaluation and reporting. For example, in LTE networks, the adjusted measurement value can be used for evaluation and reporting of events such as A2 and A3 events.

In instances in which the fading condition of the cell 304 over a measurement period did not exceed the threshold, then the network configured filter coefficient can be used to calculate the filtered measurement for use in reporting and evaluation in lieu of performance of operations 520-550.

Referring now to FIG. 6, FIG. 6 illustrates a flowchart according to an example method for determining existence of a fading condition and initiating adaptive filtering according to some example embodiments. In this regard, FIG. 6 illustrates operations that can be performed by the wireless communication device 302 attendant to performance of operation 510 in some example embodiments. One or more of processing circuitry 410, processor 412, memory 414, transceiver 416, or adaptive filtering module 418 can, for example, provide means for performing the operations illustrated in and described with respect to FIG. 6.

Operation 600 can include the wireless communication device 302 calculating a variance of the instantaneous measurement samples captured over a measurement period. For example, given n measurement samples, the variance can be calculated as follows in some example embodiments:

$$\begin{matrix}Mean = \frac{{\sum }_{k = 1}^{n} {x}_{k}}{n} & [ 1 ] \\ Variance = \frac{{\sum }_{k = 1}^{n} {( {x}_{k} - Mean )}^{2}}{n} & [ 2 ]\end{matrix}$$

Operation 610 can include comparing the variance calculated in operation 600 to a threshold variance to determine if the calculated variance exceeds the threshold variance. In an instance in which it is determined at operation 610 that the calculated variance exceeds the threshold variance, the method can proceed to operation 620, which can include determining that the facing condition of the cell 304 over the measurement period exceeds the threshold. Operations 520-550, as illustrated in and described with respect to FIG. 5 can accordingly be performed in response to operation 620. If, however, it is determined at operation 610 that the calculated variance does not exceed the threshold variance, the method can instead proceed to operation 630, which can include determining that the fading condition of the cell 304 does not exceed the threshold and using the network configured filter coefficient for calculating the filtered cell measurement.

In some example embodiments, a second threshold can be applied in instances in which a fading condition of the cell 304 exceeds a threshold over a measurement period and a modified filter coefficient is used. In this regard, a filtered measurement value calculated using a modified filter coefficient can be clipped if a difference between a filtered measurement value calculated in a previous measurement period and the filtered measurement value calculated using the modified filter coefficient exceeds a second threshold, the filtered measurement value calculated based on the modified filter coefficient can be clipped, such as by a constant, ε, to reduce an amount of fluctuation between filtered measurement values. FIG. 7 illustrates a flowchart according to an example method for adaptive filtering of cell measurements in accordance with such embodiments applying a second threshold. In this regard, FIG. 7 illustrates operations that can be performed by the wireless communication device 302. One or more of processing circuitry 410, processor 412, memory 414, transceiver 416, or adaptive filtering module 418 can, for example, provide means for performing the operations illustrated in and described with respect to FIG. 7.

With reference to FIG. 7, operation 700 can include the wireless communication device 302 calculating a first filtered measurement (F₁) indicative of a channel condition of the cell 304 over a first measurement period based on the network configured filter coefficient. The wireless communication device can maintain F₁ for later use, such as in a buffer. Operation 710 can include the wireless communication device 302 determining based at least in part on a plurality of instantaneous measurement samples of the cell 304 over a second measurement period that a fading condition of the cell 304 over the second measurement period exceeds a first threshold. In this regard, operation 710 can correspond to operation 510.

Operation 720 can include the wireless communication device 302 modifying the network configured filter coefficient to derive a modified filter coefficient in response to the fading condition of the cell exceeding the first threshold over the second measurement period. Operation 720 can correspond to operation 520. Operation 730 can, in turn include the wireless communication device 302 filtering the plurality of instantaneous measurement samples captured over the second measurement period based on the modified filter coefficient to calculate a second filtered measurement of the cell (F₂). In this regard, operation 730 can correspond to operation 530.

Operation 740 can include the wireless communication device 302 comparing F₁ and F₂ to determine if the difference between F₂ and F₁ exceeds the second threshold. In an instance in which it is determined at operation 740 that the difference between the filtered measurements does not exceed the second threshold, the method can proceed to operation 750, which can include calculating an adjusted measurement value directly from F₂. If, however, it is determined at operation 740 that the difference between the filtered measurements does exceed the second threshold, the method can proceed to operations 760 and 770 in lieu of operation 750. Operation 760 can include the wireless communication device 302 clipping F₂ by ε to derive a clipped value, F₂+/−ε. Operation 770 can include the wireless communication device 302 calculating the adjusted measurement value from the clipped value.

The method can proceed to operation 780 after performance of either operation 750 or operation 770. Operation 780 can include the wireless communication device 302 using the adjusted measurement value for event evaluation and reporting. In this regard, operation 780 can correspond to operation 550.

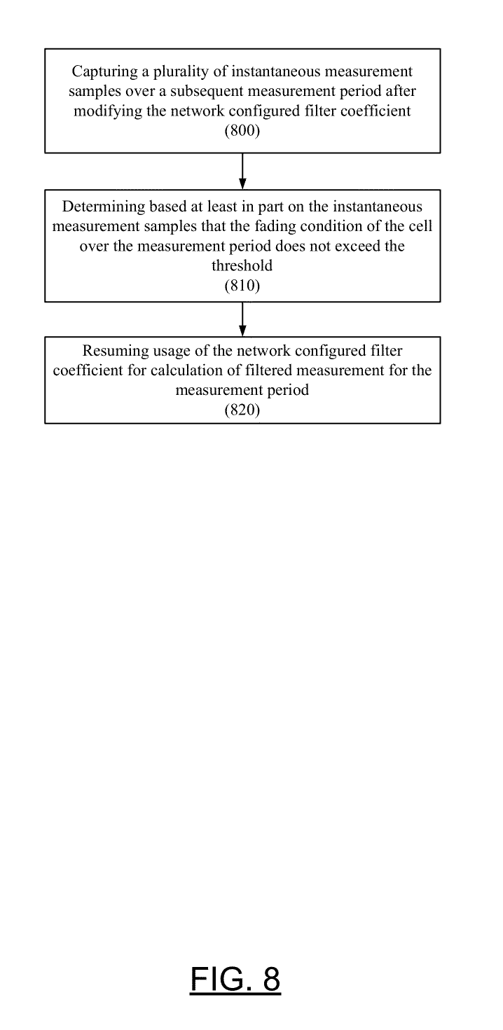

In some example embodiments instantaneous measurement samples can be monitored by the wireless communication device 302 on a rolling basis. Thus, if the wireless communication device 302 determines for a measurement period subsequent to using a modified filter coefficient that a fading condition of the cell for that measurement period does not exceed a threshold, then the wireless communication device 302 can return to using the network configured filter coefficient for filtered measurement calculation. FIG. 8 illustrates a flowchart according to an example method for resuming usage of a network configured filter coefficient after initiation of adaptive filtering according to some such example embodiments. One or more of processing circuitry 410, processor 412, memory 414, transceiver 416, or adaptive filtering module 418 can, for example, provide means for performing the operations illustrated in and described with respect to FIG. 8. Operation 800 can include the wireless communication device 302 capturing a plurality of instantaneous measurement samples over a subsequent measurement period. Operation 810 can include the wireless communication device 810 determining based at least in part on the instantaneous measurement samples that the fading condition of the cell over the measurement period does not exceed the threshold. For example, operation 810 can include determining that a statistical spread or variance of the samples does not exceed a threshold spread or variance. In some example embodiments, the method illustrated in and described with respect to FIG. 6 can be used for performance of operation 810. Operation 820 can include the wireless communication device 302 resuming usage of the network configured filter coefficient for calculation of filtered measurements in response to the determination of operation 810.

### Example Calculation of Modified Filter Coefficient and Sample Test Results

Having now described several example embodiments, example derivations of modified filter coefficients will now be described in accordance with some example embodiments. It will be appreciated that these example techniques for deriving modified filter coefficients can be applied in accordance with various example embodiments described herein. Thus, for example, these techniques for derivation of a modified filter coefficient can be used to facilitate performance of operation 520 and/or operation 720 in accordance with some example embodiments.

Calculation of a filtered measurement value can be defined as follows in accordance with some example embodiments:

y[n]=(1−α)y[n−1]+αx[n], [3]

where:
x[n] is the last received instantaneous measurement from physical layer;
y[n] is the updated filtered measurement result that can be used for event evaluation and/or measurement reporting;
y[n−1] is the old filtered measurement value used for measurement report with y[0] set to x[0]; and

$$α = {2}^{- \frac{k}{4}}$$

where ‘k’ is the network configured filter coefficient, such as can be defined by “quantity config” in an RRC message.

Taking the Z-transform of equation [3] can yield the filter transfer function H[z], as follows:

$$H [ z ] = \frac{α}{1 - ( 1 - α ) {z}^{- 1}} \qquad [ 4 ]$$

A filter can accordingly be designed having a pole at (1−α) based on equation [4]. Comparing the filter with the Z-transform of an exponential decay function with time constant ‘Ts’ can yield:

$${e}^{- \frac{nTs}{τ}} u [ n ] ↔ \frac{1}{1 - ( {e}^{\frac{- Ts}{τ}} ) {z}^{- 1}} \qquad [ 5 ]$$

The measurement period can be defined as Ts, and the wireless communication device 302 can capture measurement samples at a sampling rate of its choice. For purposes of non-limiting example, let Ts=200 ms and Ts′ be the selected sampling rate. It will be appreciated, however, that other measurement periods can be used in accordance with various example embodiments. Given the hypothetical measurement period and sampling rates, it can be inferred from equations [4] and [5] that:

$${e}^{\frac{- Ts}{τ}} = 1 - α \qquad [ 6 ]$$

The time constant of the filter that can be defined for use in a network with measurement periodicity Ts and the filter that can be used by the wireless communication device 302 with a different sampling rate can be defined to be equivalent. As such, the filter coefficient α′ can be derived in accordance with equations [7] and [8] as set forth below:

$$\frac{Ts}{ln ( 1 - α )} = \frac{{Ts}^{′}}{ln ( 1 - {α}^{′} )} \qquad [ 7 ]$$

From equation [7], the filter coefficient α′ can be defined as:

$${α}^{′} = 1 - {( 1 - α )}^{\frac{{Ts}^{′}}{Ts}} \qquad [ 8 ]$$

However in fading channel conditions and/or other high mobility conditions, the wireless communication device 302 can move between one base station and another, which can lead to a sudden degradation of pilot channel power with a simultaneous increase of neighboring cell pilot channel power. In such conditions, the network specification defined measurement periodicity and time constant can be too long for the filtered values to converge and track the instantaneous measurement samples. The wireless communication device 302 can be configured to temporarily modify the filter coefficient (e.g., for a short period of time) so that the filter converges to the instantaneous measurement samples more quickly when such conditions are encountered.

For example, let {x₁, x₂, x₃, x₄, . . . xₙ} be the last n measured instantaneous values (over a measurement period, such as a 200 ms period). The weighted variance, σ, of the samples can be defined as follows:

$$\begin{matrix}σ = \frac{{\sum }_{i = 1}^{n} {{w}_{i} ( {x}_{i} - μ )}^{2}}{n} , \\ where , & [ 9 ] \\ μ = \frac{{\sum }_{i = 1}^{n} {w}_{i} {x}_{i}}{n} & [ 10 ]\end{matrix}$$

wᵢ, as used in equations [9] and [10] denote weights that can be selected by the wireless communication device 302 based at least in part on channel conditions. The wireless communication device 302 can increase α′ by factor ‘m’ depending on σ. Similarly, the wireless communication device 302 can decrease α′ by m if σ is determined to be below a threshold. The resulting filtering equation using the modified filter coefficient can accordingly be defined as:

y[n]=(1−α^{1/m})y[n−1]+α^{1/m}x[n] [11]

The convergence of a filter in accordance with equation [11] can be implicitly guaranteed by the convergence of the network defined filter. In some example embodiments, if the newly filtered value due to filter coefficient y_{α′}[n] is greater than y_{α}[n−1] by a threshold, then the newly y_{α′}[n] can be set to y_{α}[n].

Table 1 illustrates a comparison of instantaneous measurement samples and filtered measurement values using the static filter defined by equation [3] from a set of test measurements.

TABLE 2

| | Instantaneous | | Filtered | | Filter | |
|---|---|---|---|---|---|---|
| Time | RSRP- | RSRP | Filtered- | Filtered | Coeff | |
| in ms | Cell 1 | Cell 2 | Cell 1 | Cell 2 | K | Alpha′ |
| 0 | −82 | −106 | −82 | −106 | 3 | 0.1654 |
| 40 | −82 | −106 | −82 | −106 | 3 | 0.1654 |
| 80 | −82 | −106 | −82 | −106 | 3 | 0.1654 |
| 120 | −82 | −106 | −82 | −106 | 3 | 0.1654 |
| 160 | −88 | −100 | −82.9 | −105 | 0.75 | 0.3436 |
| 200 | −94 | −94 | −86.7 | −101.2 | 0.375 | 0.4249 |
| 240 | −100 | −88 | −92.4 | −95.6 | 0.1875 | 0.4977 |
| 280 | −106 | −82 | −99.1 | −88.8 | 0.1875 | 0.4977 |
| 320 | −106 | −82 | −102.6 | −85.4 | | |

As can be seen from Table 1, the filtered values can diverge significantly from the instantaneous measurement samples over time when using the static filter. In contrast, Table 2 illustrates a comparison of instantaneous measurement samples and filtered measurement values when using the adaptive filter defined in equation [11] from the same set of test measurements.

TABLE 1

| | Instantaneous | | Filtered | | Fileter | |
|---|---|---|---|---|---|---|
| Time | RSRP- | RSRP | RSRP | RSRP | Coeff | |
| in ms | Cell 1 | Cell 2 | Cell 1 | Cell 2 | K | Alpha |
| 0 | −82 | −106 | −82 | −106 | 3 | 0.1653 |
| 40 | −82 | −106 | −82 | −106 | 3 | 0.1653 |
| 80 | −82 | −106 | −82 | −106 | 3 | 0.1653 |
| 120 | −82 | −106 | −82 | −106 | 3 | 0.1653 |
| 160 | −88 | −100 | −82.9 | −105 | 3 | 0.1653 |
| 200 | −94 | −94 | −84.8 | −102.2 | 3 | 0.1653 |
| 240 | −100 | −88 | −87.3 | −100.8 | 3 | 0.1653 |
| 280 | −106 | −82 | −90.4 | −97.7 | 3 | 0.1653 |
| 320 | −106 | −82 | −92.97 | −95.11 | | |

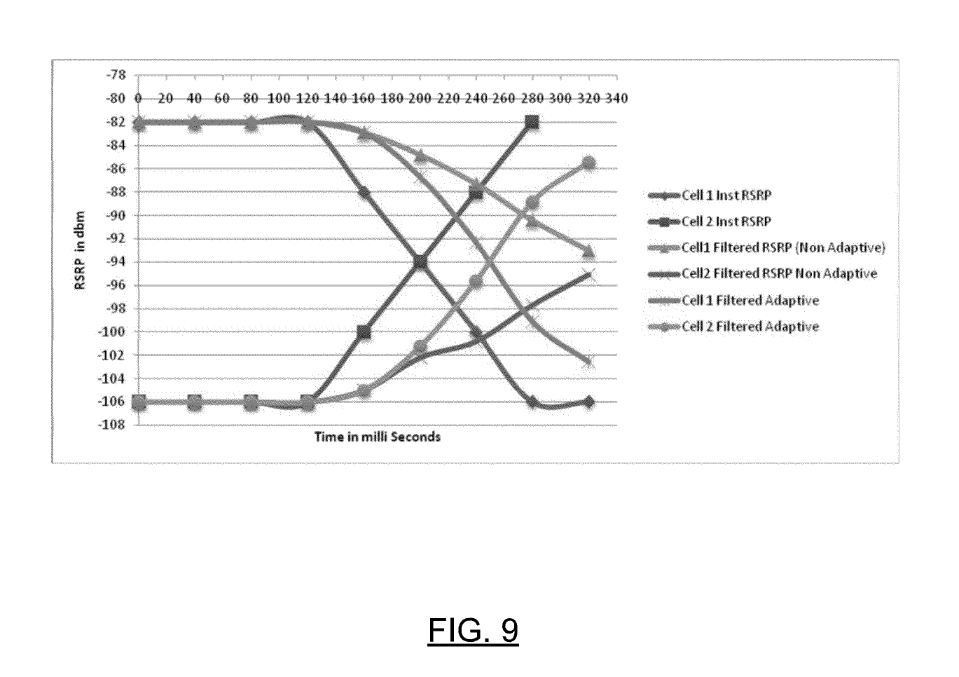

FIG. 9 illustrates a graph of instantaneous versus filtered measurements for the static filter and adaptive filter values set forth in Table 1 and Table 2.

### CONCLUSION

The various aspects, embodiments, implementations or features of the described embodiments can be used separately or in any combination. Various aspects of the described embodiments can be implemented by software, hardware or a combination of hardware and software. The described embodiments can also be embodied as computer readable code on a computer readable medium for controlling manufacturing operations or as computer readable code on a computer readable medium for controlling a manufacturing line. The computer readable medium is any data storage device that can store data which can thereafter be read by a computer system. Examples of the computer readable medium include read-only memory, random-access memory, CD-ROMs, HDDs, DVDs, magnetic tape, and optical data storage devices. The computer readable medium can also be distributed over network-coupled computer systems so that the computer readable code is stored and executed in a distributed fashion.

The foregoing description, for purposes of explanation, used specific nomenclature to provide a thorough understanding of the described embodiments. However, it will be apparent to one skilled in the art that the specific details are not required in order to practice the described embodiments. Thus, the foregoing descriptions of specific embodiments are presented for purposes of illustration and description. They are not intended to be exhaustive or to limit the described embodiments to the precise forms disclosed. It will be apparent to one of ordinary skill in the art that many modifications and variations are possible in view of the above teachings.

What is claimed is:

1. A method for adaptive filtering of cell measurements, the method comprising a wireless communication device:
calculating a first filtered measurement of a cell based on a network configured filter coefficient, the first filtered measurement indicative of a channel condition of the cell over a first measurement period;
determining based at least in part on a plurality of instantaneous measurement samples of the cell captured over a second measurement period that a fading condition of the cell over the second measurement period exceeds a first threshold;
modifying the network configured filter coefficient to derive a modified filter coefficient in response to the fading condition of the cell exceeding the first threshold over the second measurement period;
filtering the plurality of instantaneous measurement samples based on the modified filter coefficient to calculate a second filtered measurement of the cell;
comparing the first filtered measurement and the second filtered measurement;
in an instance in which a difference between the second filtered measurement and the first filtered measurement exceeds a second threshold:
clipping the second filtered measurement to derive a clipped value; and
calculating an adjusted measurement value for the cell based at least in part on the clipped value;
in an instance in which the difference between the second filtered measurement and the first filtered measurement does not exceed the second threshold, calculating the adjusted measurement value directly from the second filtered measurement value; and
using the adjusted measurement value for event evaluation and reporting.

2. The method of claim 1, wherein the cell comprises a cell of a network using a Long Term Evolution (LTE) technology, and wherein calculating the adjusted measurement value comprises calculating one or more of a reference signal received power (RSRP) value or a reference signal received quality (RSRQ) value.

3. The method of claim 1, wherein determining that the fading condition of the cell exceeds the first threshold comprises:
calculating a variance of the plurality of instantaneous measurement samples of the cell captured over the second measurement period; and
determining that the variance exceeds the first threshold.

4. The method of claim 1, wherein modifying the network configured filter coefficient comprises increasing the network configured filter coefficient by a factor k.

5. The method of claim 4, wherein k is a static value.

6. The method of claim 4, wherein k is a value selected based at least in part on an extent of the fading condition over the second measurement period.

7. The method of claim 1, wherein the plurality of instantaneous measurement samples are filtered based on the network configured filter coefficient in an instance in which the fading condition of the cell does not exceed the first threshold over the second measurement period.

8. The method of claim 1, further comprising the wireless communication device:
capturing a plurality of instantaneous measurement samples over a third measurement period;
determining based at least in part on the plurality of instantaneous measurement samples captured over the third measurement period that a fading condition over the third measurement period does not exceed the first threshold; and
resuming usage of the network configured filter coefficient in response to the fading condition over the third measurement period not exceeding the first threshold.

9. A method for adaptive filtering of cell measurements, the method comprising a wireless communication device:
determining based at least in part on a plurality of instantaneous measurement samples of a cell captured over a measurement period that a fading condition of the cell over the measurement period exceeds a threshold;
modifying a network configured filter coefficient to derive a modified filter coefficient in response to the fading condition of the cell exceeding the threshold over the measurement period;
filtering the plurality of instantaneous measurement samples based on the modified filter coefficient to calculate a filtered measurement of the cell;
calculating an adjusted measurement value for the cell based at least in part on the filtered measurement; and
using the adjusted measurement value for event evaluation and reporting.

10. The method of claim 9, further comprising:
comparing the filtered measurement and a second filtered measurement calculated for a previous measurement period based on the network configured filter coefficient; and
in an instance in which a difference between the filtered measurement and the second filtered measurement exceeds a second threshold, calculating the adjusted measurement value comprises:
clipping the filtered measurement to derive a clipped value; and
calculating the adjusted measurement value based at least in part on the clipped value.

11. The method of claim 9, wherein the cell comprises a cell of a network using a Long Term Evolution (LTE) technology, and wherein calculating the adjusted measurement value comprises calculating one or more of a reference signal received power (RSRP) value or a reference signal received quality (RSRQ) value.

12. The method of claim 9, wherein determining that the fading condition of the cell exceeds the threshold comprises:
calculating a variance of the plurality of instantaneous measurement samples of the cell captured over the measurement period; and
determining that the variance exceeds the threshold.

13. The method of claim 9, wherein modifying the network configured filter coefficient comprises increasing the network configured filter coefficient by a factor k.

14. The method of claim 9, wherein the plurality of instantaneous measurement samples are filtered based on the network configured filter coefficient in an instance in which the fading condition of the cell does not exceed the threshold over the measurement period.

15. A wireless communication device comprising:
a transceiver configured to transmit data to and receive data from a cellular network; and
processing circuitry coupled to the transceiver, the processing circuitry configured to control the wireless communication device to at least:
determine based at least in part on a plurality of instantaneous measurement samples of a cell captured over a measurement period that a fading condition of the cell over the measurement period exceeds a threshold;
modify a network configured filter coefficient to derive a modified filter coefficient in response to the fading condition of the cell exceeding the threshold over the measurement period;
filter the plurality of instantaneous measurement samples based on the modified filter coefficient to calculate a filtered measurement of the cell;
calculate an adjusted measurement value for the cell based at least in part on the filtered measurement; and
use the adjusted measurement value for event evaluation and reporting.

16. The wireless communication device of claim 15, wherein the processing circuitry is further configured to control the wireless communication device to:
compare the filtered measurement and a second filtered measurement calculated for a previous measurement period based on the network configured filter coefficient; and
in an instance in which a difference between the filtered measurement and the second filtered measurement exceeds a second threshold, calculate the adjusted measurement value at least in part by:
clipping the filtered measurement to derive a clipped value; and
calculating the adjusted measurement value based at least in part on the clipped value.

17. The wireless communication device of claim 15, wherein the cellular network is a network using a Long Term Evolution (LTE) technology, and wherein the adjusted measurement value comprises one or more of a reference signal received power (RSRP) value or a reference signal received quality (RSRQ) value for the cell.

18. The wireless communication device of claim 15, wherein the processing circuitry is further configured to control the wireless communication device to determine that the fading condition of the cell exceeds the threshold at least in part by:
calculating a variance of the plurality of instantaneous measurement samples of the cell captured over the measurement period; and
determining that the variance exceeds the threshold.

19. The wireless communication device of claim 15, wherein the processing circuitry is further configured to control the wireless communication device to modify the network configured filter coefficient at least in part by increasing the network configured filter coefficient by a factor k.

20. A computer program product for adaptive filtering of cell measurements, the computer program product comprising at least one non-transitory computer readable storage medium having computer program code stored thereon, the computer program code comprising:
program code for determining based at least in part on a plurality of instantaneous measurement samples of a cell captured over a measurement period that a fading condition of the cell over the measurement period exceeds a threshold;
program code for modifying a network configured filter coefficient to derive a modified filter coefficient in response to the fading condition of the cell exceeding the threshold over the measurement period;
program code for filtering the plurality of instantaneous measurement samples based on the modified filter coefficient to calculate a filtered measurement of the cell;
program code for calculating an adjusted measurement value for the cell based at least in part on the filtered measurement; and
program code for using the adjusted measurement value for event evaluation and reporting.

21. The computer program product of claim 20, further comprising:
program code for comparing the filtered measurement and a second filtered measurement calculated for a previous measurement period based on the network configured filter coefficient;
program code for clipping the filtered measurement to derive a clipped value in an instance in which a difference between the filtered measurement and the second filtered measurement exceeds a second threshold; and
program code for calculating the adjusted measurement value based at least in part on the clipped value in an instance in which the difference between the filtered measurement and the second filtered measurement exceeds a second threshold.

22. The computer program product of claim 20, wherein the cell comprises a cell of a network using a Long Term Evolution (LTE) technology, and wherein the program code for calculating the adjusted measurement value comprises program code for calculating one or more of a reference signal received power (RSRP) value or a reference signal received quality (RSRQ) value.

23. The computer program product of claim 20, wherein the program code for determining that the fading condition of the cell exceeds the threshold comprises:
program code for calculating a variance of the plurality of instantaneous measurement samples of the cell captured over the measurement period; and
program code for determining that the variance exceeds the threshold.

24. The computer program product of claim 20, wherein the program code for modifying the network configured filter coefficient comprises program code for increasing the network configured filter coefficient by a factor k.
